(19) United States
(12) Patent Application Publication
(10) Pub. No.: US 2008/0243268 A1
(43) Pub. Date: Oct. 2, 2008

(54) ADAPTIVE CONTROL OF MULTIPLE PREFETCHERS

(76) Inventors: Meenakshi A. Kandaswamy, Portland, OR (US); Simon C. Steely, Hudson, NH (US)

Correspondence Address: SCHWEGMAN, LUNDBERG & WOESSNER, P.A., P.O. BOX 2938, MINNEAPOLIS, MN, 55402, US

(21) Appl. No.: 11/695,022

(22) Filed: Mar. 31, 2007

(51) Int. Cl. G05B 13/02; G06F 9/30

(52) U.S. Cl. 700/28; 712/207; 712/E09.016

(57) ABSTRACT

According to one example embodiment of the inventive subject matter, there is provided a mechanism that controls which prefetchers are applied to execute an application in a computing system by turning them on and off. In one embodiment, this may be accomplished for example with a software control process that may run in the background. In another example embodiment, this may be accomplished using a hardware control machine, or a combination of hardware and software. The prefetchers are turned on and off in order to increase the performance of the computing system.

### TECHNICAL FIELD

Various embodiments described herein relate to computer technology generally, including adaptive control of multiple prefetchers in a computing system.

### BACKGROUND

In computer architecture, instruction prefetch is a technique used in microprocessors to speed up the execution of a program by reducing wait states. In at least some cases, modern microprocessors are much faster than the memory where the program is kept, meaning that the program's instructions cannot be read fast enough to keep the microprocessor busy. Prefetch is the processor action of getting an instruction from the memory well before it will need it. In this way, the processor will not need to wait for the memory to answer its request.

The prefetched instruction may simply be the next instruction in the program, fetched while the current instruction is being executed. Or, the prefetch may be part of a complex branch prediction algorithm, where the processor tries to anticipate the result of a calculation and fetch the right instructions in advance.

### BRIEF DESCRIPTION OF THE DRAWINGS

FIG. 1 is a flow diagram illustrating a method according to various embodiments of the inventive subject matter.

FIG. 2 is a block diagram of a computing system according to one embodiment of the inventive subject matter.

### DETAILED DESCRIPTION

The trend for cache and memory hierarchy design in computing systems is to include multiple prefetchers. This may include more than one per level in a cache hierarchy and often different types of prefetchers. These prefetchers are not always complementary and different applications perform better with different combinations of prefetchers. Some systems, for example, include two prefetchers at a first cache-level and two-prefetchers at a second cache-level. According to one example embodiment of the inventive subject matter, there is provided a mechanism that controls which prefetchers are applied by turning them on and off. In one embodiment, this may be accomplished for example with a software control process that may run in the background. In another example embodiment, this may be accomplished using a hardware control machine, or a combination of hardware and software.

According to one example embodiment of the inventive subject matter, there is provided a background system software control process that uses the cycles per instruction (CPI) and/or misses per instruction (MPI) calculated by the hardware as the metric for measuring the performance and adapts to the prefetcher combination that achieves the best performance. According to one example embodiment, the control process has access to the Hardware Prefetch model specific registers (MSRs). The software goes through a multi-step process which measures the performance of several combinations of the prefetchers and then stays with the best performing combination. According to one example embodiment, there are two triggers which re-initiate the measurement process:
1. time period passes, or
2. CPI, MPI or other measurement changes by threshold amount to indicate a change in phase.

It shall be understood, however, that any trigger or measurement may be used to establish which combination of prefetchers yields the best result. In addition, the inventive subject matter further provides for simulating results and performance and controlling the prefetchers used prior to actual execution, as opposed to adjusting the prefetchers after actual results have been detected.

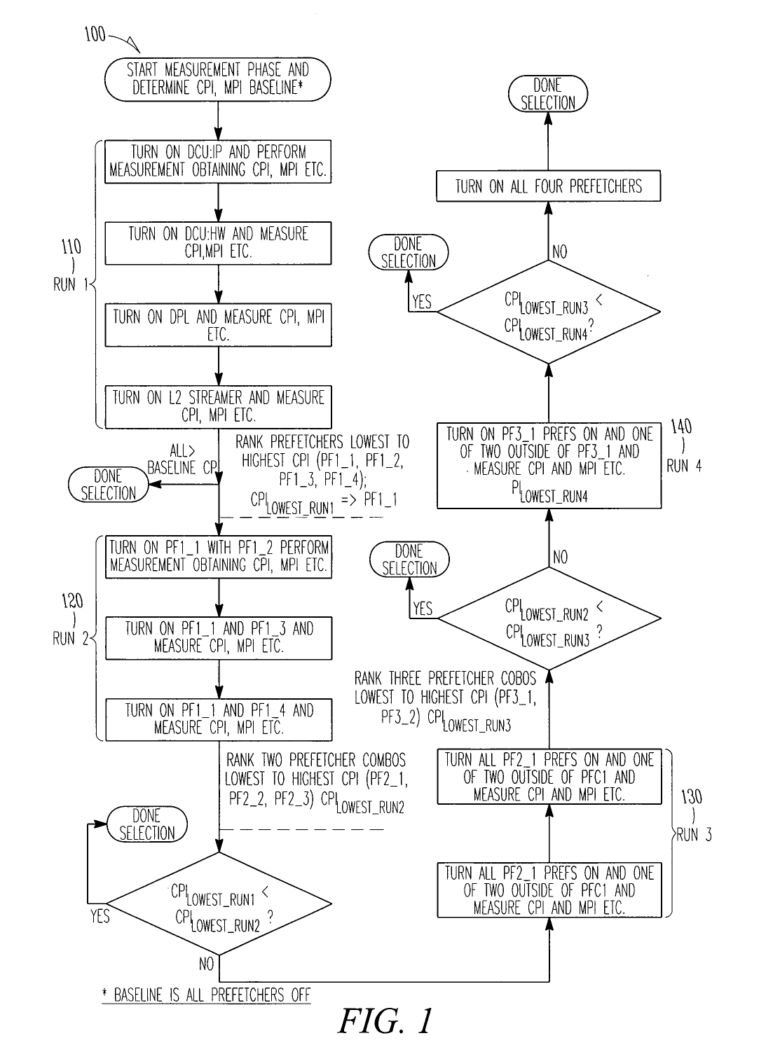

FIG. 1 shows an example flowchart of how one example embodiment 100 of a control process may work. The measurement phase starts off by obtaining a baseline CPI and/or MPI or some other measurement. Run-stage 1 indicated as 110, tries out each prefetcher individually to determine which one performs best (is named PF1_1 in flowchart). Note it is possible that none of the prefetchers improve performance and then this test process terminates with no prefetchers on. (This could happen with either memory bound applications or with programs that have very good software prefetching or access patterns that are not prefetchable with the prefetchers).

Run stage 2, indicated as 120, tries out the best performing prefetcher (PF1_1) in combination with each of the other prefetchers. Only if a combination outperforms PF1_1 does it continue.

Run stage 3, indicated as 130, combines the best combination from Run stage 2 with each of the remaining prefetchers to find the best three-way combination. Here again, only if a combination outperforms the best two-way does this test stage continue.

Run stage 4, indicated as 140, tries out all prefetchers on. At this point the test phase ends by choosing all or the best three.

When the measurement process is done the application runs in the chosen prefetcher combination for a significant period of time or until the CPI and/or MPI changes by a significant threshold and then re-initiates the measurement phase.

Note an alternate but more sophisticated control process is to make a tree of each combination of prefetchers and at the measurement phase try the neighbors (take-away one of the prefetchers in the combination or add an additional prefetcher) and move to the neighbor if it is more performance.

According to another example embodiment, the inventive subject matter works well with software prefetching as well as varying software optimizations as well as varying quality of prefetchers. In one example embodiment it sits on top of the memory fetching hierarchy and by measuring the achieved performance chooses complementary combinations for the overall best solution. If software improves and some hardware prefetcher becomes unnecessary the inventive subject matter provides for turning off or disabling the offending prefetcher. Further, while in one example embodiment the prefetchers are turned on or off, other ways to enable or disable the prefetchers wholly or partially may also be used. As such, for example, a prefetcher may be completely turned off or disabled, or only partially turned off or disabled, in any combination, using the approach described herein.

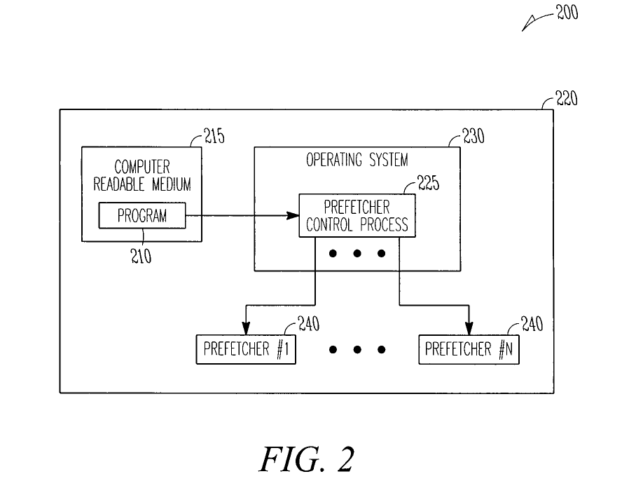

According to one example embodiment 200 illustrated in FIG. 2, a computer program 210 embodying any one of the example adaptive control techniques described above may be launched from a computer-readable medium 215 in a computer-based system 220 to execute functions defined in the computer program. In particular, computer program 210 may operate in the background of an operating system 230 on system 220 to execute a pre-fetcher control process 225 to turn on and off or otherwise control a plurality of pre-fetchers 240. Various programming languages may be employed to create software programs designed to implement and perform the methods disclosed herein.

This has been a detailed description of some exemplary embodiments of the inventive subject matter(s) contained within the disclosed subject matter. Such inventive subject matter(s) may be referred to, individually and/or collectively, herein by the term “inventive subject matter” merely for convenience and without intending to limit the scope of this application to any single inventive subject matter or inventive concept if more than one is in fact disclosed. The detailed description refers to the accompanying drawings that form a part hereof and which show by way of illustration, but not of limitation, some specific embodiments of the inventive subject matter, including a preferred embodiment. These embodiments are described in sufficient detail to enable those of ordinary skill in the art to understand and implement the inventive subject matter. Other embodiments may be utilized and changes may be made without departing from the scope of the inventive subject matter. It may be possible to execute the activities described herein in an order other than the order described. And, various activities described with respect to the methods identified herein can be executed in repetitive, serial, or parallel fashion.

Such embodiments of the inventive subject matter may be referred to herein individually or collectively by the term “inventive subject matter” merely for convenience and without intending to voluntarily limit the scope of this application to any single inventive subject matter or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In the foregoing Detailed Description, various features are grouped together in a single embodiment for the purpose of streamlining the disclosure. This method of disclosure is not to be interpreted as reflecting an intention that the claimed embodiments of the inventive subject matter require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment.

It will be readily understood to those skilled in the art that various other changes in the details, material, and arrangements of the parts and method stages which have been described and illustrated in order to explain the nature of this inventive subject matter may be made without departing from the principles and scope of the inventive subject matter as expressed in the subjoined claims.

It is emphasized that the Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

What is claimed is:

1. A method comprising:
executing an application on a computing system with more than one prefetcher;
testing the efficiency of the system executing the application using one or more combinations of the prefetchers;
configuring the operation of the prefetchers by activating or deactivating in whole or in part the one or more prefetchers in response to the testing of the efficiency of the system; and
continuing to execute the application using the configuration of the prefetchers.

2. A method according to claim 1 further wherein at least two of the prefetchers are of a different type and have different capabilities.

3. A method according to claim 1 further including establishing a baseline of efficiency of the system as part of testing the efficiency of the system executing the application.

4. A method according to claim 1 wherein at least two of the prefetchers are on different levels of a memory cache.

5. A method according to claim 1 further wherein the prefetchers are activated or deactivated using a process that runs in the background of the computing system.

6. A method according to claim 1 wherein the process is performed by software, hardware or a combination of software and hardware.

7. A method according to claim 1 further including measuring cycles per instruction or misses per instruction to determine the efficiency of the computing system.

8. A system comprising:
a computing device having one or more prefetchers;
executing an application on the computing device;
at least one process operating on the computing device to test the efficiency of the system executing the application using one or more combinations of the prefetchers;
the process including at least one portion to configure the operation of the prefetchers by activating or deactivating in whole or in part the one or more prefetchers in response to the testing of the efficiency of the system.

9. A system according to claim 8 further wherein at least two of the prefetchers are of a different type and have different capabilities.

10. A system according to claim 8 further including establishing a baseline of efficiency of the system as part of testing the efficiency of the system executing the application.

11. A system according to claim 8 wherein at least two of the prefetchers are on different levels of a memory cache.

12. A system according to claim 8 further wherein the process runs in the background of the computing system.

13. A system according to claim 8 wherein the process is performed by software, hardware or a combination of software and hardware.

14. A system according to claim 8 further wherein the process includes at least one portion to measure cycles per instruction or misses per instruction to determine the efficiency of the computing system.

15. A system according to claim 8 wherein the process includes at least one portion to determine when to reevaluate the configuration of the prefetchers base on an amount of time that has passed since the last evaluation or a change in a measurement of performance.
